(19) United States
(12) Patent Application Publication
(10) Pub. No.: US 2025/0373086 A1
(43) Pub. Date: Dec. 4, 2025

(54) METHODOLOGY FOR PARALLEL RESONANT SERIES-SERIES (PRSS) TUNING FOR WIRELESS INDUCTIVE POWER TRANSFER SYSTEMS

(71) Applicants: Mayank Chawla, Logan, UT (US); Abhilash Kamineni, North Logan, UT (US); Dragan Maksimovic, Boulder, CO (US)

(72) Inventors: Mayank Chawla, Logan, UT (US); Abhilash Kamineni, North Logan, UT (US); Dragan Maksimovic, Boulder, CO (US)

(73) Assignees: Utah State University, Logan, UT (US); The Regents of the University of Colorado, Denver, CO (US)

(21) Appl. No.: 19/170,996

(22) Filed: Apr. 4, 2025

Related U.S. Application Data
(60) Provisional application No. 63/656,061, filed on Jun. 4, 2024.

(51) Int. Cl. H02J 50/70; G06F 30/367; G06F 119/06; H02J 50/00; H02J 50/12

(52) U.S. Cl. CPC H02J 50/70; G06F 30/367; H02J 50/005; H02J 50/12; G06F 2119/06

(57) ABSTRACT

A power converter includes switching section, tuning section, and rectification section. The tuning section includes transformer with a primary inductance and a secondary inductance and a primary series capacitor connected in series with a primary winding and a secondary series capacitor connected in series with a secondary winding. The primary series capacitor is selected with a resonant frequency with the primary inductance and the secondary series capacitor is selected with the resonant frequency with the secondary inductance. The tuning section includes a resonant tank with a primary parallel capacitor connected in parallel with the primary series capacitor and the primary winding and a primary resonant inductor connected between the switching section and a connection to the primary parallel capacitor. An input impedance of the resonant tank at a switching frequency is below a frequency intersecting an open circuit input impedance and a short circuit input impedance of the resonant tank.

### CROSS-REFERENCES TO RELATED APPLICATIONS

This application claims the benefit of U.S. Provisional Patent Application No. 63/656,061 entitled “METHODOLOGY FOR PARALLEL RESONANT SERIES-SERIES (PRSS) TUNING FOR WIRELESS INDUCTIVE POWER TRANSFER SYSTEMS” and filed on Jun. 4, 2024 for Mayank Chawla et al., which is incorporated herein by reference.

### GOVERNMENT RIGHTS

This invention was made with government support under Contract No. 1941524 awarded by the National Science Foundation. The government has certain rights in the invention.

### FIELD

This invention relates to switching power converters and more particularly relates to parallel resonant series-series tuning of a switching power converter.

### BACKGROUND

Wireless inductive power transfer (IPT) systems have numerous industry applications today which include charging portable devices, electric vehicle charging, biomedical implants and various other applications. A double-sided inductor-capacitor-capacitor (LCC) compensation and its tuning method for IPT systems is widely used for IPT systems. Misalignment between the primary and secondary coils causes a decrease in coupling between the primary and secondary coils, which often leads to a drop in power transferred to the secondary.

### SUMMARY

A power converter includes a switching section, a tuning section with an input connected to an output of the switching section, and a rectification section with an input connected to an output of the tuning section and an output connectable to a load. The tuning section includes a loosely coupled transformer with a primary inductance Lₚ and a secondary inductance Lₛ and a primary series capacitor Cₚₛ connected in series with a primary winding of the transformer and a secondary series capacitor Cₛₛ connected in series with a secondary winding of the transformer. The primary series capacitor Cₚₛ is chosen to be at a resonant frequency ωᵣ with the primary inductance Lₚ and the secondary series capacitor Cₛₛ is chosen to be at the resonant frequency ωᵣ with the secondary inductance Lₛ. The tuning section includes a primary parallel capacitor Cₚₚ, of a parallel resonant tank connected in parallel with the primary series capacitor Cₚₛ and the primary winding and a primary resonant inductor Lₚᵣ, of the parallel resonant tank connected in series between the output of the switching section and a connection between the primary parallel capacitor Cₚₚ and the primary series capacitor Cₚₛ. An input impedance Zᵢ of the parallel resonant tank at a switching frequency ωₛ is below an intersection frequency fₘ intersecting an open circuit input impedance Z_{i∞}of the parallel resonant tank and a short circuit input impedance Zᵢ₀ of the parallel resonant tank.

A method for designing a PRSS power converter includes selecting a primary inductance Lₚ, a secondary inductance Lₛ, a primary resistance rₚ, a secondary resistance rₛ, a primary quality factor Q₁, and a secondary quality factor Q₂ for a loosely coupled transformer comprising a primary charging pad and a secondary pad, a range of coupling coefficients k of the transformer, and a switching frequency ωₛ of a switching section of the power converter and selecting a capacitance for a primary series capacitor Cₚₛ connected in series with a primary winding of the transformer and a secondary series capacitor Cₛₛ connected in series with a secondary winding of the transformer. The capacitance of the primary series capacitor Cₚₛ is chosen to be at a resonant frequency ωᵣ with the primary inductance Lₚ and the capacitance of the secondary series capacitor Cₛₛ is chosen to be at the resonant frequency ωᵣ with the secondary inductance Lₛ. The resonant frequency, is equal to the switching frequency ωₛ. The method includes selecting a capacitance of a primary parallel capacitor Cₚₚ, of a parallel resonant tank connected in parallel with the primary series capacitor Cₚₛ and the primary winding and an inductance of a primary resonant inductor Lₚᵣ, of the parallel resonant tank, connected in series between the output of the switching section and a connection between the primary parallel capacitor Cₚₚ and the primary series capacitor Cₚₛ. An input impedance Zᵢ of the parallel resonant tank at a switching frequency ωₛ is below an intersection frequency fₘ intersecting an open circuit input impedance Z_{i∞} of the parallel resonant tank and a short circuit input impedance Zᵢ₀ of the parallel resonant tank. The WPT power converter includes a rectification section with an input connected to an output of the tuning section and an output connectable to a load.

A wireless power transfer (“WPT”) power converter includes a switching section with four semiconductor switches arranged in an H-bridge, a tuning section with an input connected to an output of the switching section, and a rectification section with an input connected to an output of the tuning section and an output connectable to a load. The rectification section is configured as an H-bridge rectifier with an output capacitor C_{f} across output terminals of the output of the rectification section. The secondary winding and the rectification section are one of mobile and stationary. The tuning section includes a loosely coupled transformer with a primary inductance Lₚ and a secondary inductance Lₛ, where the transformer includes an air gap between the primary winding configured as a primary charging pad and the secondary winding where the secondary winding and the rectification section are mobile. The tuning section includes a primary series capacitor Cₚₛ connected in series with a primary winding of the transformer and a secondary series capacitor Cₛₛ connected in series with a secondary winding of the transformer. The primary series capacitor Cₚₛ is chosen to be at a resonant frequency ωᵣ with the primary inductance Lₚ and the secondary series capacitor Cₛₛ is chosen to be at the resonant frequency ωᵣ with the secondary inductance Lₛ. The resonant frequency ωᵣ is equal to the switching frequency ωₛ. The tuning section includes a primary parallel capacitor Cₚₚ, of a parallel resonant tank connected in parallel with the primary series capacitor Cₚₛ and the primary winding, and a primary resonant inductor Lₚᵣ, of the parallel resonant tank connected in series between the output of the switching section and a connection between the primary parallel capacitor Cₚₚ and the primary series capacitor Cₚₛ. An input impedance Zᵢ of the parallel resonant tank at a switching frequency ωₛ is below an intersection frequency fₘ intersecting an open circuit input impedance Z_{i∞}of the parallel resonant tank and a short circuit input impedance Zᵢ₀ of the parallel resonant tank. The intersection frequency fₘ is defined as:

$${f}_{m} = \frac{1}{2 π \sqrt{2 {L}_{p r} {C}_{pp}}} .$$

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating an inductive power transfer system with series-series compensation, according to various embodiments;

FIG. 2 is a schematic block diagram illustrating an equivalent circuit of the inductive power transfer system with series-series compensation of FIG. 1, according to various embodiments;

FIG. 3 is a parallel resonant series-series (PRSS) tuning system, according to various embodiments;

FIG. 4A is a schematic block diagram of an equivalent circuit of the PRSS tuning of FIG. 3, according to various embodiments;

FIG. 4B is a schematic block diagram of an equivalent circuit with impedance Zᵢ of the PRSS tuning of FIG. 3, according to various embodiments;

FIG. 4C is a schematic block diagram of a transformer model for an equivalent circuit of the PRSS tuning of FIG. 3, according to various embodiments;

FIG. 4D is a schematic block diagram of the transformer model of FIG. 4C referred to the primary circuit, according to various embodiments;

FIG. 5 is a plot of impedance |Zᵢ| for a parallel LC tank for limiting cases |Zᵢ|→0 and |Zᵢ₁|→∞, according to various embodiments;

FIG. 6 is a diagram depicting a v-i characteristic for |Zᵢ₁|=|Zᵢ₁|ₙₒₘ, where | |Zᵢ₁|ₙₒₘ is a nominal value of |Zᵢ₁|, according to various embodiments;

FIG. 7 is a plot of short circuit input impedance Zᵢ₀ and open circuit input impedance Z_{i∞} for an LC tank design for PRSS tuning; according to various embodiments;

FIG. 8 is a plot of input impedance Zᵢ versus frequency for PRSS tuning, according to various embodiments;

FIG. 9 is a plot of open circuit gain |H| versus frequency for PRSS tuning, according to various embodiments; and

FIG. 10 is a plot of output power (kW) versus coupling coefficient (k) curves for PRSS, S-S, and LCC-LCC tuning, according to various embodiments.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

A power converter includes a switching section, a tuning section with an input connected to an output of the switching section, and a rectification section with an input connected to an output of the tuning section and an output connectable to a load. The tuning section includes a loosely coupled transformer with a primary inductance Lₚ and a secondary inductance Lₛ and a primary series capacitor Cₚₛ connected in series with a primary winding of the transformer and a secondary series capacitor Cₛₛ connected in series with a secondary winding of the transformer. The primary series capacitor Cₚₛ is chosen to be at a resonant frequency ωᵣ with the primary inductance Lₚ and the secondary series capacitor Cₛₛ is chosen to be at the resonant frequency ωᵣ with the secondary inductance Lₛ. The tuning section includes a primary parallel capacitor Cₚₚ, of a parallel resonant tank connected in parallel with the primary series capacitor Cₚₛ and the primary winding and a primary resonant inductor Lₚᵣ, of the parallel resonant tank connected in series between the output of the switching section and a connection between the primary parallel capacitor Cₚₚ and the primary series capacitor Cₚₛ. An input impedance Zᵢ of the parallel resonant tank at a switching frequency ωₛ is below an intersection frequency fₘ intersecting an open circuit input impedance Z_{i∞}of the parallel resonant tank and a short circuit input impedance Zᵢ₀ of the parallel resonant tank.

In some embodiments, the switching section includes four switches arranged in an H-bridge and the rectification section is configured as an H-bridge rectifier with an output capacitor C_{f} across output terminals of the output of the rectification section. In other embodiments, the switches of the switching section are semiconductor switches and the rectifier section includes diodes or semiconductor switches. In other embodiments, the transformer includes an air gap between the primary winding configured as a fixed primary charging pad and the secondary winding. The secondary winding and the rectification section are mobile or fixed.

In some embodiments, the intersection frequency fₘ is defined as:

$${f}_{m} = \frac{1}{2 π \sqrt{2 {L}_{pr} {C}_{p p}}} .$$

In other embodiments, the primary winding and the secondary winding are coupled with a coupling coefficient k that is related to root-mean-square (RMS) current I_{Prms} at the primary series capacitor Cₚₛ while output power Pₒᵤₜ at the load is substantially constant according to the equation:

$${P}_{out} = \frac{{{ω}_{r}^{2} ( k \sqrt{{L}_{p} {L}_{s}} )}^{2} {I}_{P r m s}^{2}}{{R}_{L} + {r}_{s}} ,$$

wherein:
rₛ is a resistance of the secondary winding; and
R_{L} is a load impedance from an input to the rectification section.
   As used herein, output power Pₒᵤₜ at the load being substantially constant includes that the output power may vary about 25%, as depicted in FIG. 10.

In some embodiments, the primary resonant inductor Lₚᵣ and the primary parallel capacitor Cₚₚ are chosen such that the switching section operates as zero voltage switching for a conditions where the input impedance Zᵢ₁ at the primary series capacitor Cₚₛ at the resonant frequency ωᵣ are defined by:

$$\vert {Z}_{i 1} ( {ω}_{r} ) \vert < {R}_{crit} , \\ where \\ {R}_{crit} = \vert {Z}_{o 0} \vert \sqrt{\frac{- {Z}_{i ∞}}{{Z}_{io}}} , \\ {ω}_{s} = {ω}_{r} , \\ {X}_{s} = {ω}_{s} {L}_{pr} , \\ {X}_{p} = - \frac{1}{{ω}_{s} {C}_{p p}} , \\ {Z}_{i 0} = j {X}_{s} , \\ {Z}_{i ∞} = j {X}_{s} + j {X}_{p} , \\ and \\ {Z}_{o 0} ( j {ω}_{z} ) = \frac{j {X}_{p} {X}_{s}}{{X}_{p} + {X}_{s}} .$$

A method for designing a PRSS power converter includes selecting a primary inductance Lₚ, a secondary inductance Lₛ, a primary resistance rₚ, a secondary resistance rₛ, a primary quality factor Q₁, and a secondary quality factor Q₂ for a loosely coupled transformer comprising a primary charging pad and a secondary pad, a range of coupling coefficients k of the transformer, and a switching frequency ωₛ of a switching section of the power converter. The method includes selecting a capacitance for a primary series capacitor Cₚₛ connected in series with a primary winding of the transformer and a secondary series capacitor Cₛₛ connected in series with a secondary winding of the transformer. The capacitance of the primary series capacitor Cₚₛ is chosen to be at a resonant frequency Or with the primary inductance Lₚ and the capacitance of the secondary series capacitor Cₛₛ is chosen to be at the resonant frequency ωᵣ with the secondary inductance Lₛ. The resonant frequency ωᵣ is equal to the switching frequency ωₛ. The method includes selecting a capacitance of a primary parallel capacitor Cₚₚ, of a parallel resonant tank connected in parallel with the primary series capacitor Cₚₛ and the primary winding and an inductance of a primary resonant inductor Lₚᵣ, of the parallel resonant tank, connected in series between the output of the switching section and a connection between the primary parallel capacitor Cₚₚ and the primary series capacitor Cₚₛ. An input impedance Zᵢ of the parallel resonant tank at a switching frequency ωₛ is below an intersection frequency fₘ intersecting an open circuit input impedance Z_{i∞}of the parallel resonant tank and a short circuit input impedance Zᵢ₀ of the parallel resonant tank. The WPT power converter includes a rectification section with an input connected to an output of the tuning section and an output connectable to a load.

In some embodiments, the switching section comprises four switches arranged in an H-bridge and the rectification section is configured as an H-bridge rectifier with an output capacitor C_{f} across output terminals of the output of the rectification section. In other embodiments, the transformer includes an air gap between the primary winding configured as a fixed primary charging pad and the secondary winding configured. The secondary winding and the rectification section are mobile or stationary. In other embodiments, the intersection frequency fₘ is defined as:

$${f}_{m} = \frac{1}{2 π \sqrt{2 {L}_{p r} {C}_{p p}}} .$$

In some embodiments, selecting the capacitance of the primary parallel capacitor Cₚₚ and the inductance of the primary resonant inductor Lₚᵣ includes selecting the capacitance of the primary parallel capacitor Cₚₚ and the inductance of the primary resonant inductor Lₚᵣ to meet zero voltage switching conditions where the input impedance Zᵢ₁ at the primary series capacitor Cₚₛ at the resonant frequency ωᵣ are defined by:

$$\vert {Z}_{i 1} ( {ω}_{r} ) \vert < {R}_{crit} , \\ where \\ {R}_{crit} = \vert {Z}_{o 0} \vert \sqrt{\frac{- {Z}_{i ∞}}{{Z}_{io}}} , \\ {ω}_{s} = {ω}_{r} , \\ {X}_{s} = {ω}_{s} {L}_{pr} , \\ {X}_{p} = - \frac{1}{{ω}_{s} {C}_{p p}} , \\ {Z}_{i 0} = j {X}_{s} , \\ {Z}_{i ∞} = j {X}_{s} + j {X}_{p} , \\ and \\ {Z}_{o 0} ( j {ω}_{z} ) = \frac{j {X}_{p} {X}_{s}}{{X}_{p} + {X}_{s}} .$$

In some embodiments, the method includes selecting an output voltage Vₒᵤₜ and output power Pₒᵤₜ at the load and determining an equivalent load resistance R_{L} at an input to the rectification section based on the selected output voltage Vₒᵤₜ and output power Pₒᵤₜ at the load, where:

$${R}_{L} = \frac{8 {V}_{o u t}^{2}}{{π}^{2} {P}_{o u t}} .$$

In other embodiments,, for a lowest coupling coefficient k in a selected range, the method includes calculating an absolute value of input impedance |Zᵢ₁| at the primary series capacitor Cₚₛ at the resonant frequency ωᵣ, where the primary winding and the secondary winding are coupled with the coupling coefficient k and the input impedance Zᵢ₁ at the primary series capacitor Cₚₛ is defined as:

$${Z}_{i 1} ( {ω}_{r} ) = {r}_{s} + \frac{{{ω}_{r}^{2} ( k \sqrt{{L}_{p} {L}_{s}} )}^{2}}{{R}_{L} + {r}_{s}} ,$$

and calculating a root-mean-square (“RMS”) value of current I_{Prms} at the primary series capacitor Cₚₛ is

$${I}_{P r m s} = \frac{{I}_{p}}{\sqrt{2}}$$

wherein Iₚ comprises an input current to the primary series capacitor Cₚₛ. is

In some embodiments, the method includes selecting a maximum open circuit voltage V_{oc} and a maximum short circuit current I_{sc} at the primary series capacitor Cₚₛ based on:

$$\frac{{\vert v \vert}^{2}}{{V}_{oc}^{2}} + \frac{{\vert {i}_{p} \vert}^{2}}{{I}_{SC}^{2}} = 1.$$

A wireless power transfer (“WPT”) power converter includes a switching section with four semiconductor switches arranged in an H-bridge, a tuning section with an input connected to an output of the switching section, and a rectification section with an input connected to an output of the tuning section and an output connectable to a load. The rectification section is configured as an H-bridge rectifier with an output capacitor C_{f} across output terminals of the output of the rectification section. The tuning section includes a loosely coupled transformer with a primary inductance Lₚ and a secondary inductance Lₛ, where the transformer includes an air gap between the primary winding configured as a primary charging pad and the secondary winding where the secondary winding and the rectification section are mobile or stationary. The tuning section includes a primary series capacitor Cₚₛ connected in series with a primary winding of the transformer and a secondary series capacitor Cₛₛ connected in series with a secondary winding of the transformer. The primary series capacitor Cₚₛ is chosen to be at a resonant frequency ωᵣ with the primary inductance Lₚ and the secondary series capacitor Cₛₛ is chosen to be at the resonant frequency ωᵣ with the secondary inductance Lₛ. The resonant frequency ωᵣ is equal to the switching frequency ωₛ. The tuning section includes a primary parallel capacitor Cₚₚ, of a parallel resonant tank connected in parallel with the primary series capacitor Cₚₛ and the primary winding, and a primary resonant inductor Lₚᵣ, of the parallel resonant tank connected in series between the output of the switching section and a connection between the primary parallel capacitor Cₚₚ and the primary series capacitor Cₚₛ. An input impedance Zᵢ of the parallel resonant tank at a switching frequency ωₛ is below an intersection frequency fₘ intersecting an open circuit input impedance Z_{i∞}of the parallel resonant tank and a short circuit input impedance Zᵢ₀ of the parallel resonant tank. The intersection frequency fₘ is defined as:

$${f}_{m} = \frac{1}{2 π \sqrt{2 {L}_{p r} {C}_{p p}}} ;$$

and

In some embodiments, the primary winding and the secondary winding are coupled with a coupling coefficient k that is related to root-mean-square (RMS) current I_{Prms} at the primary series capacitor Cₚₛ while output power Pₒᵤₜ at the load is substantially constant according to the equation:

$${P}_{out} = \frac{{{ω}_{r}^{2} ( k \sqrt{{L}_{p} {L}_{s}} )}^{2} {I}_{P r m s}^{2}}{{R}_{L} + {r}_{s}} ,$$

wherein:
rₛ is a resistance of the secondary winding; and
R_{L} is a load impedance from an input to the rectification section.

In some embodiments, the primary resonant inductor Lₚᵣ and the primary parallel capacitor Cₚₚ are chosen such that the switching section operates as zero voltage switching for a conditions where the input impedance Zᵢ₁ at the primary series capacitor Cₚₛ at the resonant frequency or are defined by:

$$\vert {Z}_{i 1} ( {ω}_{r} ) \vert < {R}_{crit} , \\ where \\ {R}_{crit} = \vert {Z}_{o 0} \vert \sqrt{\frac{- {Z}_{i ∞}}{{Z}_{io}}} , \\ {ω}_{s} = {ω}_{r} , \\ {X}_{s} = {ω}_{s} {L}_{pr} , \\ {X}_{p} = - \frac{1}{{ω}_{s} {C}_{p p}} , \\ {Z}_{i 0} = j {X}_{s} , \\ {Z}_{i ∞} = j {X}_{s} + j {X}_{p} , \\ and \\ {Z}_{o 0} ( j {ω}_{z} ) = \frac{j {X}_{p} {X}_{s}}{{X}_{p} + {X}_{s}} .$$

In some embodiments, for a selected output voltage Vₒᵤₜ and for a selected output power Pₒᵤₜ at the load, an equivalent load resistance R_{L} at an input to the rectification section is based on the selected output voltage Vₒᵤₜ and output power Pₒᵤₜ at the load, where:

$${R}_{L} = \frac{8 {V}_{o u t}^{2}}{{π}^{2} {P}_{o u t}} .$$

In other embodiments, a root-mean-square (RMS) value of current I_{Prms} at the primary series capacitor Cₚₛ is calculated as

$${I}_{P r m s} = \frac{{I}_{p}}{\sqrt{2}}$$

where Iₚ includes an input current to the primary series capacitor Cₚₛ, where the primary winding and the secondary winding are coupled with a coupling coefficient k and the input impedance Zᵢ₁ at the primary series capacitor Cₚₛ at the resonant frequency ωᵣ is defined as:

$${Z}_{i 1} ( {ω}_{r} ) = {r}_{s} + \frac{{{ω}_{r}^{2} ( k \sqrt{{L}_{p} {L}_{s}} )}^{2}}{{R}_{L} + {r}_{s}} ,$$

where:
rₛ is a resistance of the secondary winding; and
R_{L} is a load impedance from an input to the rectification section, and a maximum open circuit voltage V_{oc} and a maximum short circuit current I_{sc} at the input at the primary series capacitor Cₚₛ are determined based on:

$$\frac{{\vert v \vert}^{2}}{{v}_{oc}^{2}} + \frac{{\vert {i}_{p} \vert}^{2}}{{I}_{SC}^{2}} = 1.$$

### I. INTRODUCTION

Wireless inductive power transfer (IPT) systems have numerous industry applications today which include charging portable devices, electric vehicle charging, biomedical implants and various other applications. There are several companies working on IPT systems such as Apple®, WiTricity®, Wave IPT™, Qualcomm® and many other companies which work on different IPT applications. A double-sided inductor-capacitor-capacitor (LCC) compensation and its tuning method for IPT systems is widely used for IPT systems.

Misalignment between the primary and secondary coils causes a decrease in coupling between the primary and secondary coils, which often leads to a drop in power transferred to the secondary. However, it is desirable to have a relatively constant output power regardless of the misalignment. Therefore, to compensate for the misalignment system designers often use complex coil structures and extra converters for IPT systems. Coil design techniques have been explored to reduce the effects of misalignment on the coupling coefficient which increases the complexity of the coil design for IPT systems. A series hybrid topology to improve the misalignment tolerance of IPT systems is proposed, however this topology uses polarized magnetic coupler. Zero voltage switching (ZVS) analysis is an important factor for high power IPT systems.

A parallel resonant series-series (PRSS) tuning method is proposed for IPT systems to deliver nearly constant power from primary to secondary for a range of coupling coefficient k without any external controls required. The design of tuning method is based on the coupling coefficient k between the primary and secondary coils and can be used for any type of coil. Moreover, for the PRSS design, the range of coupling coefficient over which nearly constant power is desired can be selected by the designer, which helps in designing the PRSS tuning method for both static and dynamic IPT systems.

### II. PARALLEL RESONANT SERIES-SERIES (PRSS) TUNING

### A. Background Of Series-Series Compensation

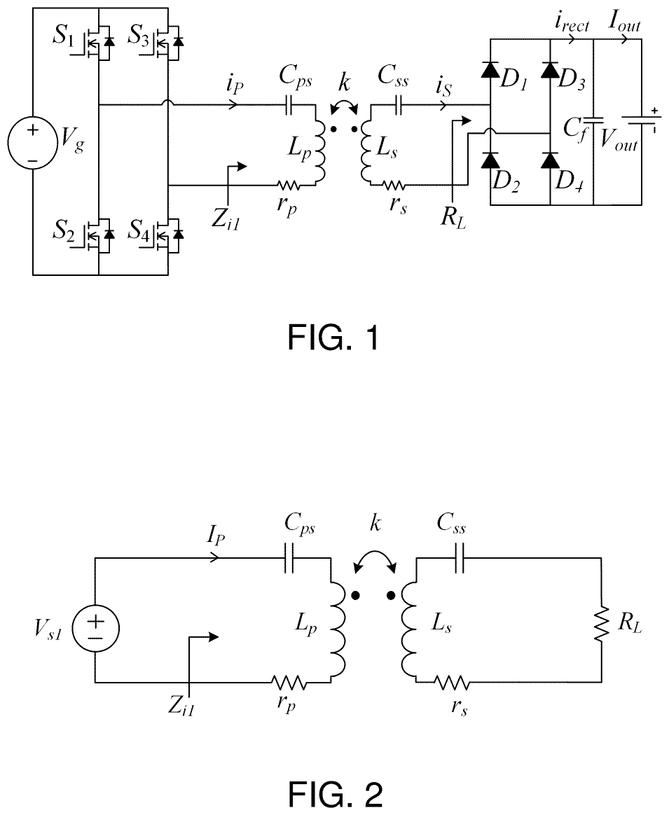

The PRSS tuning method described herein for IPT systems is a further extension of a series-series compensation. In FIG. 1, Vg is the input direct current (DC) voltage, Lₚ and Lₛ are the self-inductances of primary and secondary coils respectively, rₚ and rₛ are the equivalent series resistances of the primary and secondary coils respectively, k is the coupling coefficient between primary and secondary coil, M is defined as the mutual inductance between the two coils and given in equation (1), and Cₚₛ and Cₛₛ are the compensation capacitors for Lₚ and Lₛ respectively. Vₒᵤₜ and Iout are the output voltage and current. FIG. 2 represents an equivalent circuit of series-series compensation where the inverter and rectifier of FIG. 1 are modeled using sinusoidal approximation. Vₛ₁ is the peak value of fundamental component of output voltage of an H-bridge inverter by sinusoidal approximation as shown in FIG. 2 and given in equation (2). R_{L} in FIG. 2 is the equivalent load resistance seen from the rectifier circuit as shown in FIG. 1 and is given in equation (3). Zur is the input impedance seen from the point shown in FIG. 2. If Lₛ and Lₚ are compensated by Cₛₛ and Cₚₛ respectively using series-series compensation operating at the switching frequency ωₛ equal to the resonant frequency ωᵣ, Zᵢ₁ is purely resistive which can be analyzed using a T-model of coupled inductors for a series-series compensation and Zᵢ at ωᵣ denoted as Zᵢ (ωᵣ) is given in equation (4).

$$M = k \sqrt{{L}_{p} {L}_{s}} \qquad ( 1 )$$

$${V}_{s 1} = \frac{4}{π} {V}_{g} \qquad ( 2 )$$

$${R}_{L} = \frac{8 {V}_{o u t}^{2}}{{π}^{2} {P}_{o u t}} \qquad ( 3 )$$

$${Z}_{i 1} ( {ω}_{r} ) = {r}_{p} + \frac{{ω}_{r}^{2} {M}^{2}}{{R}_{L} + {r}_{s}} \qquad ( 4 )$$

The power transferred to the secondary circuit for series-series compensation in FIG. 2 is given in equation (5), where I_{Prms} is the root-mean-square (RMS) value of iₚ in FIG. 1. Pₒᵤₜ is defined as output power given in equation (6) and is nearly equal to power transferred to the secondary Pₛ given in equation (5).

$${P}_{s} = \frac{{ω}_{r}^{2} {M}^{2}}{{R}_{L} + {r}_{s}} {I}_{Prms}^{2} \qquad ( 5 )$$

$${P}_{out} = {V}_{out} {I}_{out} \qquad ( 6 )$$

From the series-series compensation, it can be observed from the power transfer equation (5), that if the resonant frequency ωᵣ, the equivalent load resistance R_{L} and the equivalent series resistance rₛ are kept constant, the power transfer to secondary can be changed by either changing I_{Prms} or M. With misalignments in the IPT system, the value of coupling coefficient k will decrease, due to which M will decrease from equation (1), and from equation (5) it is possible to maintain a nearly constant power for a range of k by increasing I_{Prms} slightly as k decreases.

### B. Introduction To PRSS Tuning

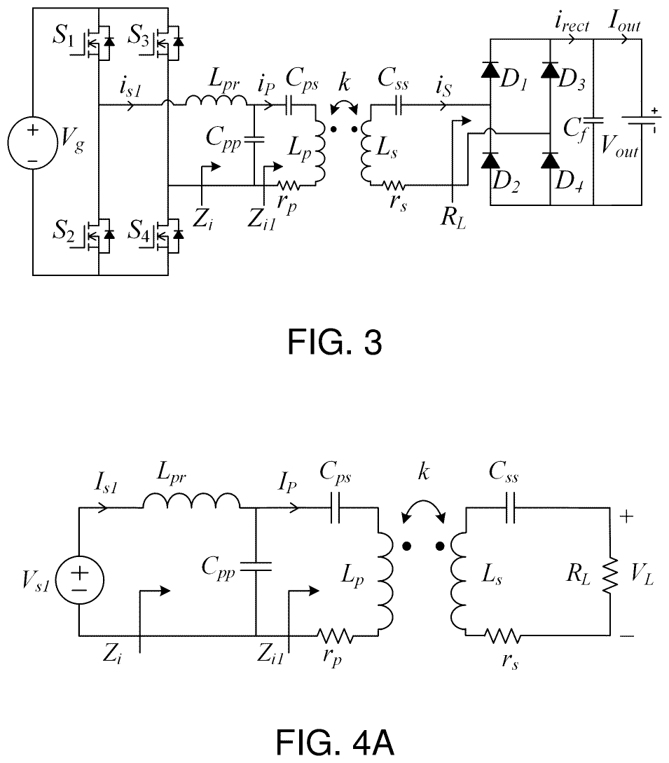

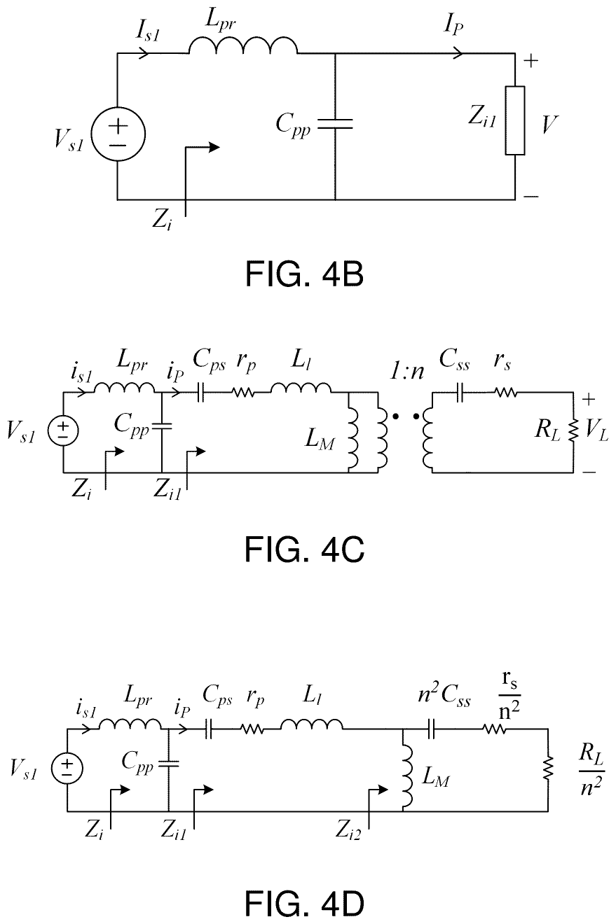

FIG. 3 represents the PRSS tuning, where a parallel resonant tank is added before a series-series compensation. Lₚᵣ and Cₚₚ in FIG. 3 are the inductance and capacitance of a parallel resonant tank respectively. FIG. 4A represents an equivalent circuit for PRSS tuning in FIG. 3. Vₛ₁ is the peak value of fundamental component of output voltage of H-bridge inverter by sinusoidal approximation and given in equation (2), Zᵢ and Zᵢ₁ are the input impedance from the point shown in FIG. 4A. If the system is operated at the switching frequency (ωₛ) equal to the resonant frequency (ωᵣ) of Lₚ and Cₚₛ, and Lₛ and Cₛₛ, then Zᵢ₁ is purely resistive and is equal to Zᵢ₁ (ωᵣ) as mentioned in Section II A.

The equivalent model of FIG. 4A can be represented in FIG. 4B, where a parallel resonant tank has a resistive load of Zᵢ₁ at resonant frequency ωᵣ. The expression for peak value for input current to the series-series section iₚ and peak value of current to the parallel resonant tank Iₛ₁ in FIG. 4A are given in equations (7) and (8), where s is equal to jω.

$${I}_{P} = \vert \frac{\frac{1}{{sC}_{pp}}}{{Z}_{i 1} + \frac{1}{{sC}_{pp}}} \vert {I}_{s 1} \qquad ( 7 )$$

$${I}_{s 1} = \frac{{V}_{S 1}}{\vert {Z}_{i} \vert} \qquad ( 8 )$$

$${I}_{P r m s} = \frac{{I}_{p}}{\sqrt{2}} . \qquad ( 9 )$$

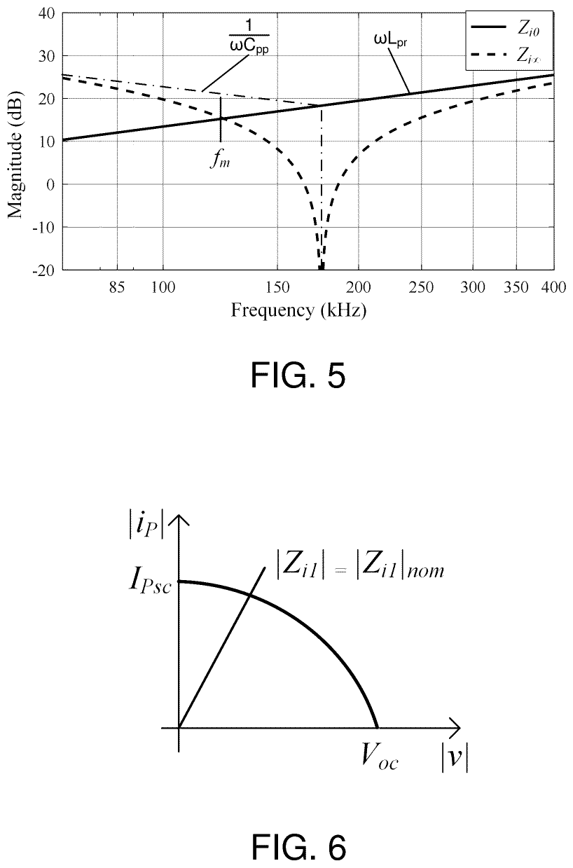

It should be noted that I_{Prms} given in equation (9) is the current that is responsible for transferring power in proposed tuning as mentioned in series-series compensation given in equation (5). It can also be observed from equation (4), as the value of k decreases, the value of | Zᵢ₁ (ωᵣ) | also decreases. In FIG. 4B, |Zᵢ| is the resistive load to the parallel resonant tank at ωᵣ. FIG. 5 represents the behavior of input impedance |Zᵢ| with resistive load |Zᵢ₁ where |Zᵢ₀| is the resistance when |Zᵢ₁| is shorted given in equation (10) and |Zᵢ| is the resistance when |Zᵢ₁| is open circuited given in equation (11). If the switching frequency of operation (fₛ) is less than fₘ, which is the intersection frequency of |Zᵢ₀| and |Zᵢ₁|, |Zᵢ₁ decreases with decrease in resistive load |Zᵢ₁|. With decrease in |Zᵢ₁|, |Z| should decrease below fₘ, due to which Iₛₗ and iₚ should increase. Thus, a nearly constant power can be maintained for a range of k by increasing iₚ and thus I_{Prms} slightly as k decreases.

$${Z}_{i 0} = s {L}_{p r} \qquad ( 10 )$$

$${Z}_{i ∀ ∞} = s {L}_{p r} + \frac{1}{s {C}_{pp}} . \qquad ( 11 )$$

For analyzing Zᵢ, transformer model of coupled inductors given in FIG. 4C is used, where Lᵢ, L_{M} and turns ratio n are given in equations (12), (13) and (14) respectively. Zᵢ and Zᵢ₁ in FIG. 4C are analyzed in terms of impedances defined by means of phasors rotating at frequency ω where s=jω is used for analysis. All the impedances in FIG. 4C are referred to primary side as shown in FIG. 4D, where impedance Zᵢ₂ shown in FIG. 4D is given in equation (15). FIG. 4D is then used to derive Zᵢ given in equation (16) and Zᵢ given in equation (17) in terms of Zᵢ₂.

$${L}_{l} = ( 1 - {k}^{2} ) {L}_{p} \qquad ( 12 )$$

$${L}_{M} = {k}^{2} {L}_{p} \qquad ( 13 )$$

$$n = \frac{1}{k} \sqrt{\frac{{L}_{s}}{{L}_{p}}} \qquad ( 14 )$$

$${Z}_{i 2} = \frac{( \frac{rs}{{n}^{2}} + \frac{{r}_{L}}{{n}^{2}} + \frac{1}{{sn}^{2} {C}_{ss}} ) ( {sL}_{M} )}{( \frac{rs}{{n}^{2}} + \frac{{r}_{L}}{{n}^{2}} + \frac{1}{{sn}^{2} {C}_{ss}} ) + ( {sL}_{M} )} \qquad ( 15 )$$

$${Z}_{i 1} = \frac{1}{s {C}_{p s}} + {r}_{p} + s {L}_{l} + {Z}_{i 2} \qquad ( 16 )$$

$${Z}_{i} = s {L}_{p r} + \frac{( {Z}_{i 1} ) ( \frac{1}{s {C}_{s s}} )}{( {Z}_{i 1} ) + ( \frac{1}{s {C}_{s s}} )} . \qquad ( 17 )$$

### III. DESIGN PROCEDURE FOR PRSS TUNING

### A. Detailed Design Procedure

### A. Detailed Design Procedure

This section describes the complete design procedure and steps to be followed for designing the PRSS tuning for IPT systems. The parameters in FIG. 3 are same as parameters mentioned in Section II A.
(i) The primary coil and secondary coil are designed considering the following self inductances and losses in the coil represented by Lₚ, rₚ, Lₛ and rₛ, and then also determining the quality factors Q₁ and Q₂ of primary and secondary coil respectively from equation (18):

$${Q}_{1} = \frac{{ω}_{s} {L}_{p}}{{R}_{p}} and {Q}_{2} = \frac{{ω}_{s} {L}_{s}}{{R}_{s}} . \qquad ( 18 )$$

(ii) Cₛₛ and Cₚₛ are selected using series-series compensation, where switching frequency ωₛ is kept equal to the resonant frequency ωᵣ of Lₛ and Cₛₛ, and Lₚ and Cₚₛ.

(iii) Then, determining the value of load resistance R_{L} at which the maximum efficiency occurs for a series-series tuned system using equation (19). Vₒᵤₜ in FIG. 3 is also evaluated from equation (20), where Pₒᵤₜ is output power which is a known value and is nearly equal to Pₛ, the power transferred to the secondary circuit. It should be noted here that R_{L} at maximum efficiency point is chosen for a better system performance. In a practical system, R_{L} would depend on the battery voltage of the system.

$${R}_{L} = k {r}_{s} \sqrt{{Q}_{2} {Q}_{1}} \qquad ( 19 )$$

$${V}_{out} = \sqrt{\frac{{R}_{L} {π}^{2} {P}_{o u t}}{8}} . \qquad ( 20 )$$

(iv) The magnitude of Zᵢ₁, |Zᵢ₁ mentioned in FIG. 4B is calculated at switching frequency of operation ωₛ (ωₛ=ωᵣ=2πfₛ) at lowest coupling coefficient k value for the range of constant power to be achieved from equation (4) and is equal to |Zᵢ₁ (W). [Zᵢ₁| calculated can be denoted as |Zᵢ₁|ₙₒₘ. Using this value of |Zᵢ₁|nom, calculate I_{Prms} in FIG. 4B at ωₛ from the power transfer equation given in equation (5) for a value of k that is somewhere in lower to middle range of k for constant power transfer.

(v) After the values |Zᵢ₁|ₙₒₘ and I_{Prms} from step (iv) are evaluated, determine the peak value Iₚ (Iₚ=\sqrt{2} I_{Prms}) and peak value V (V=Iₚ|Zᵢ|ₙₒₘ) denoted in FIG. 4B across |Zᵢ₁| at this operating point.

(vi) Follow a detailed design procedure for parallel resonant tank such that fₛ is less than fₘ as shown in FIG. 5 and also verify the zero voltage switching (ZVS) condition.

### B. Parallel Resonant Tank Design for PRSS Tuning

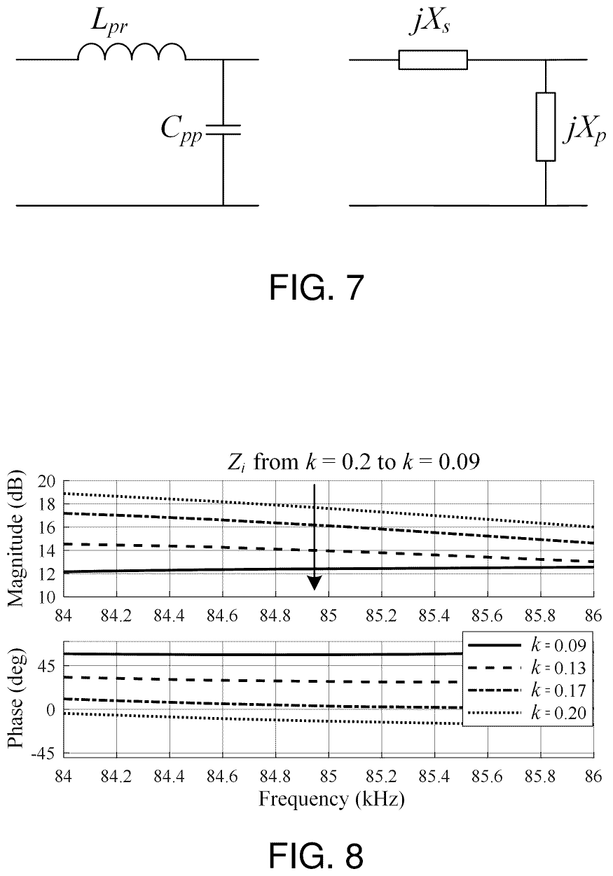

For the parallel resonant tank design of FIG. 4B and FIG. 7, solve the output v-i characteristics of the resonant inverter using the values obtained in Section III A step (vi) using equation (21). FIG. 6 is a diagram depicting a v-i characteristic for |Zᵢ₁|=|Zᵢ₁|nom, where |Zᵢ₁|ₙₒₘ is a nominal value of |Zᵢ₁|. From FIG. 6, voltage reaches a maximum at the open circuit voltage V_{oc} and the current reaches a maximum at the short circuit current I_{Psc}. V_{oc} is the peak open circuit voltage across Zᵢ₁ in FIG. 4B when Zᵢ₁→1 or Zᵢ₁ is open circuited. I_{Psc} is the peak short circuit current in Zᵢ₁ in FIG. 4B when Zᵢ₁→0 or Zᵢ₁ is shorted.

$$\frac{{V}^{2}}{{V}_{oc}^{2}} + \frac{{I}_{P}^{2}}{{I}_{Psc}^{2}} = 1 \qquad ( 21 )$$

Then finding |Zₒ₀] (magnitude of output impedance with input Vₛ₁ shorted) and |H∞| (open circuit gain in terms of tank elements) in FIG. 4B at frequency of operation ωₛ (ωₛ=ωᵣ) from equations (22) and (23).

$$\vert {Z}_{o 0} \vert = \frac{{V}_{oc}}{{I}_{Psc}} \qquad ( 22 )$$

$$\vert {H}_{∞} \vert = \frac{{V}_{oc}}{{V}_{s 1}} \qquad ( 23 )$$

Resonant tank elements in FIG. 7 are then selected to meet the specifications at frequency of operation ωₛ (ωₛ=ωᵣ):

$${X}_{s} = {ω}_{s} {L}_{p r} \qquad ( 24 )$$

$${X}_{p} = - \frac{1}{{ω}_{s} {C}_{s s}} . \qquad ( 25 )$$

Zₒ₀ (jωₛ) and H_{∞}(jωₛ) can also be found from FIG. 7 as given in equations (26) and (27) respectively. Solving for Xₛ and Xₚ from equations (29) and (28) respectively, and then finally Lₚᵣ and Cₚₚ using equations (24) and (25) respectively.

$${Z}_{o 0} ( j {ω}_{s} ) = \frac{{jX}_{p} {X}_{s}}{{X}_{p} + {X}_{s}} \qquad ( 26 )$$

$${H}_{∞} ( j {ω}_{s} ) = \frac{j {X}_{p}}{j {X}_{p} + j {X}_{s}} \qquad ( 27 )$$

$${jX}_{p} = \frac{{Z}_{o 0} ( j {ω}_{s} )}{1 - {H}_{∞} ( j {ω}_{s} )} \qquad ( 28 )$$

$${X}_{s} = {X}_{p} \frac{1 - {H}_{∞} ( j {ω}_{s} )}{{H}_{∞} ( j {ω}_{s} )} . \qquad ( 29 )$$

After solving for Lₚᵣ and Cₚₚ, it is to be verified that the switching frequency of operation (fₛ) is less than fₘ where fₘ is given in equations (30). The ZVS conditions for the inverter transistors can be verified from equations (31) and (32), where Zᵢ₀ and Zᵢ₁ are given in equations (33) and (34) respectively:

$${f}_{m} = \frac{1}{2 π \sqrt{2 {L}_{pr} {C}_{pp}}} \qquad ( 30 )$$

$$\vert {Z}_{i 1} ( {ω}_{r} ) \vert < {R}_{crit} \qquad ( 31 )$$

$${R}_{crit} = \vert {Z}_{o 0} \vert \sqrt{\frac{- {Z}_{i ∞}}{{Z}_{i o}}} \qquad ( 32 )$$

$${Z}_{i o} = j {ω}_{s} \qquad ( 33 )$$

$${Z}_{i∞} = j ( {X}_{s} + {X}_{p} ) . \qquad ( 34 )$$

### IV. Design Example of PRSS Tuning

This section provides a design example of a 10 kilowatt (kW) dynamic wireless power transfer (DWPT) system for PRSS tuning, which uses standard values of range of coupling coefficient k seen in DWPT systems, for which a nearly constant power system is designed. The design example has then been verified with simulations.

### A. Design Analysis

The parameters for the design example are provided in Table I. Then, the detailed design procedure mentioned in Section III is followed.

TABLE I
Parameters for DWPT system design of PRSS tuning.

| Parameter | Value |
|---|---|
| fs | 85 kilohertz (kHz) |
| V_{g} | 300 volts (V) |
| Lₚ | 50 microhenries (μH) |
| Lₛ | 63 μH |
| k | 0.09-0.2 |

(i) Selecting the values of Q₁ and Q₂ to be 333 and 336 respectively. The values of rₚ and rₛ calculated from equation (18) are 0.08 ohms (Ω) and 0.1Ω respectively.

(ii) Then compensating Lₚ and Lₛ from Table I with Cₚₛ and Cₛₛ respectively using series-series compensation at resonant frequency ωᵣ equal to switching frequency of operation ωₛ (ωₛ=2×fₛ). The calculated values of Cₚₛ and Cₛₛ are 70 nano farads (nF) and 56 nF respectively.

(iii) Calculating the value of R_{L} from equation (19) to be 3Ω and value of Vₒᵤₜ to be 190 V from equation (20). The value of Vₒᵤₜ is slightly adjusted to 180 V for better performance.

(iv) |Zᵢ| equal to |Zᵢ₁ (ωᵣ) | mentioned in FIG. 4B is calculated from equation (4) at fₛ. The value of |Zᵢ₁|ₙₒₘ at fₛ and k=0.09 is calculated to be 2Ω. I_{Prms} at k=0.12 at fₛ to transfer output power of 10 kW is calculated to be 50 amperes (A).

(v) V and Iₚ in FIG. 4B are calculated to be 142 V and 70.7 A respectively.

(vi) Then selecting V_{oc} to be 550 V and calculating Lₚᵣ and Cₚₚ using the detailed design procedure in Section III B to be 7.5 micro henrys (μH) and 110 nF respectively.

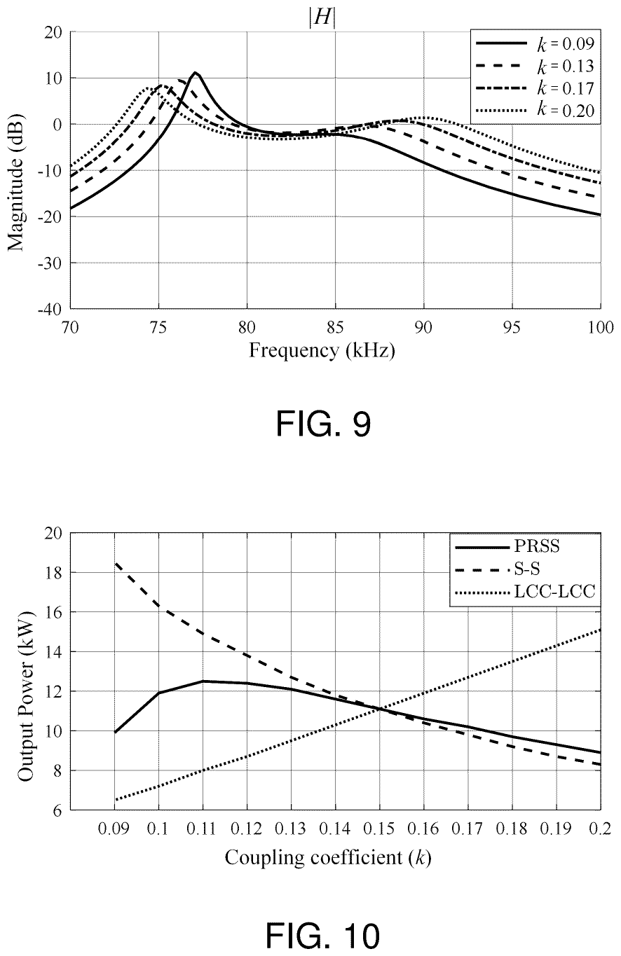

The intersection frequency of |Zᵢ₀| and |Zᵢ₁ fₘ can be obtained from equation (30) and is equal to 123 kilohertz (kHz). Rₑᵣᵢₜ at fₛ can be evaluated from equation (32) for ZVS conditions and is equal to 13.4. |Zᵢ₁ (Or) | at k=0.09 is 2Ω and at k=0.2 is 11.5Ω. Thus, the ZVS condition given in equation (31) is satisfied for entire range of k from 0.09-0.2. The plot of Zᵢ₀ and Zᵢ₁ vs frequency is given in FIG. 5, from which we can observe that switching frequency of operation (fₛ) is less than the fₘ as mentioned in Section III B. FIG. 8 shows the curve of Zᵢ vs frequency where we can observe that, at fₛ=85 kHz, |Z| decreases slightly as the value of k decreases from 0.2 to 0.09 due to which I_{Prms} increases slightly to maintain constant power transfer mentioned in Section III B. FIG. 9 shows the plot of |H| where |H| is given in equation (35), where V_{L} is the maximum voltage across R_{L} as shown in FIG. 4A. It can be observed that, since |H| is nearly constant at fₛ=85 kHz for k=0.09-0.2, V_{L} and V_{Lrms} (RMS voltage across R_{L}) are constant and since R_{L} which is equal to 3Ω for this design is constant, thus power across R_{L} (P_{L}) given in equation (36) or approximate value of output power is nearly constant.

$$\vert H \vert = \frac{{V}_{L}}{{V}_{g}} \qquad ( 35 )$$

$${P}_{L} = \frac{{V}_{Lrms}^{2}}{{R}_{L}} . \qquad ( 36 )$$

B. Simulation Results and Comparison of PRSS Tuning with S-S and LCC-LCC Tuning

The DWPT design for PRSS tuning for which the analysis is shown in Section IV A is simulated in LTspice® for which the results are shown in FIG. 10 where output power is given as a function of coupling coefficient k. PRSS curve in FIG. 10 represents the output power (kW) for PRSS tuning. It can be observed from PRSS curve that the output power remains close to 10 kW for entire range of k from 0.09-0.2, where the maximum deviation in output power from 10 kW is seen at 12.5 kW.

Table II gives the RMS voltage (V), RMS current (I) and apparent power(S) for Lₚᵣ, Cₚₚ, Cₚₛ and Lₚ shown in FIG. 3, which are obtained from the simulation results of 10 kW DWPT system for PRSS tuning. The quality factor (Q) for Lₚᵣ and Lₚ are taken to be 300, and for Cₚₚ and Cₚₛ are taken to be 1000, based on which the total loss in 4 components is calculated and given in Table II.

The values of V, I, S and total loss for k=0.09, 0.15 and 0.2 are within the bounds of any 10 KW IPT system.

TABLE II
V, I, and S for components of PRSS tuning.

| | | | |
|---|---|---|---|
| Parameter | k = 0.09 | k = 0.15 | k = 0.2 |

| | | | | | | |
|---|---|---|---|---|---|---|
| V_{Lpr} | 334 | V | 274 | V | 254 | V |
| I_{Lpr} | 66 | A | 46 | A | 39 | A |
| S_{Lpr} | 22 | kVA | 12.6 | kVA | 9.9 | kVA |
| V_{Cpp} | 195 | V | 327 | V | 347 | V |
| I_{Cpp} | 19 | A | 25 | A | 25 | A |
| S_{Cpp} | 3.7 | kVA | 8.1 | kVA | 8.6 | kVA |
| V_{Cps} | 1676 | V | 1011 | V | 751 | V |
| I_{Cps} | 62 | A | 37 | A | 28 | A |
| S_{Cps} | 103.9 | kVA | 37.4 | kVA | 21 | kVA |
| V_{Cp} | 1670 | V | 1032 | V | 801 | V |
| I_{Cp} | 62 | A | 37 | A | 28 | A |
| S_{Cp} | 103.5 | kVA | 38.1 | kVA | 22.4 | kVA |
| Total Loss | 526 | W | 214 | W | 137 | W |

This section also shows comparison of output power vs coupling coefficient k curves for PRSS, series-series and LCC-LCC tuning in FIG. 10. For comparison between different types of tuning, the output power at k=0.15 is kept same at 11 kW and the power variation for the three types of tuning is analyzed. For series-series (S-S) tuning, the output power vs k curves are obtained for parameters of a 10 kW DWPT design in Section IV A before adding the parallel LC resonant tank and are represented by S-S curve in FIG. 10. It can be observed from FIG. 10 that the output power increases as the value of k decreases from 0.2 to 0.09. The maximum output power deviation for S-S from 10 kW is seen at approximately 18 kW. Output power versus k curves are also obtained for a 10 kW double-sided LCC tuning (LCC-LCC) and are represented by LCC-LCC curve in FIG. 10. It can be observed from FIG. 10 that the output power for LCC-LCC tuning decreases as the value of k decreases from 0.2 to 0.09. The maximum output power deviation for LCC-LCC from 10 kW is seen at approximately 15 kW. From PRSS curve in FIG. 10, the output power does not vary much as the value of k decreases from 0.2 to 0.09. The output power at k=0.2 is 9 kW and at k=0.09 is 10 kW. The maximum output power deviation for LCC-LCC from 10 kW is seen at 12.5 kW.

### V. CONCLUSION

Parallel resonant series-series (PRSS) tuning method for IPT systems to maintain nearly constant power over a range of coupling coefficient k has been proposed herein. A detailed design procedure for PRSS tuning has been presented herein for achieving a nearly constant power for the range of k selected according the application of IPT system. The ZVS analysis for the proposed tuning to achieve ZVS for the inverter transistors has also been presented herein. A design example of the proposed tuning method for a DWPT system has been shown herein. The DWPT design example has been verified with simulations showing nearly constant power curve for the range of k selected. Finally, a brief comparison of the PRSS tuning with series-series and double-sided LCC tuning showing the output power curves has been done. The PRSS tuning achieved a nearly constant power for DWPT design example with minimum deviation of output power for k ranging from 0.09-0.2 compared to series-series tuning where output power increased with decrease in value of k from 0.2 to 0.09 and double-sided LCC tuning where output power decreased with decrease in value of k from 0.2 to 0.09.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A power converter comprising:
a switching section;
a tuning section with an input connected to an output of the switching section, the tuning section comprising:
a loosely coupled transformer comprising a primary inductance Lₚ and a secondary inductance Lₛ;
a primary series capacitor Cₚₛ connected in series with a primary winding of the transformer and a secondary series capacitor Cₛₛ connected in series with a secondary winding of the transformer, wherein the primary series capacitor Cₚₛ is chosen to be at a resonant frequency ωᵣ with the primary inductance Lₚ and wherein the secondary series capacitor Cₛₛ is chosen to be at the resonant frequency ωᵣ with the secondary inductance Lₛ;
a primary parallel capacitor Cₚₚ, of a parallel resonant tank connected in parallel with the primary series capacitor Cₚₛ and the primary winding; and
a primary resonant inductor Lₚᵣ, of the parallel resonant tank connected in series between the output of the switching section and a connection between the primary parallel capacitor Cₚₚ and the primary series capacitor Cₚₛ, wherein an input impedance Zᵢ of the parallel resonant tank at a switching frequency ωₛ is below an intersection frequency fₘ intersecting an open circuit input impedance Z_{i∞} of the parallel resonant tank and a short circuit input impedance Zᵢ₀ of the parallel resonant tank; and
a rectification section with an input connected to an output of the tuning section and an output connectable to a load.

2. The power converter of claim 1, wherein the switching section comprises four switches arranged in an H-bridge and the rectification section is configured as an H-bridge rectifier comprising an output capacitor C_{f} across output terminals of the output of the rectification section.

3. The power converter of claim 2, wherein the switches of the switching section are semiconductor switches and the rectifier section comprises one of diodes and semiconductor switches.

4. The power converter of claim 1, wherein the transformer comprises an air gap between the primary winding configured as a fixed primary charging pad and the secondary winding, wherein the secondary winding and the rectification section are one of mobile and stationary.

5. The power converter of claim 1, wherein the intersection frequency fₘ is defined as:
$${f}_{m} = \frac{1}{2 π \sqrt{2 {L}_{pr} {C}_{pp}}} .$$

6. The power converter of claim 1, wherein the primary winding and the secondary winding are coupled with a coupling coefficient k that is related to root-mean-square (RMS) current I_{Prms} at the primary series capacitor Cₚₛ while output power Pₒᵤₜ at the load is substantially constant according to the equation:
$${P}_{out} = \frac{{{ω}_{r}^{2} ( k \sqrt{{L}_{p} {L}_{s}} )}^{2} {I}_{P r m s}^{2}}{{R}_{L} + {r}_{s}} ,$$
wherein:
rₛ is a resistance of the secondary winding; and
R_{L} is a load impedance from an input to the rectification section.

7. The power converter of claim 1, wherein the primary resonant inductor Lₚᵣ and the primary parallel capacitor Cₚₚ are chosen wherein the switching section operates as zero voltage switching for a condition where the input impedance Zᵢ₁ at the primary series capacitor Cₚₛ at the resonant frequency ωᵣ are defined by:
$$\vert {Z}_{i 1} ( {ω}_{r} ) \vert < {R}_{crit} , \\ where \\ {R}_{crit} = \vert {Z}_{o 0} \vert \sqrt{\frac{- {Z}_{i ∞}}{{Z}_{i o}}} , {ω}_{s} = {ω}_{r} , {X}_{s} = {ω}_{s} {L}_{pr} , {X}_{p} = - \frac{1}{{ω}_{s} {C}_{p p}} , {Z}_{i 0} = j {X}_{s} , {Z}_{i ∞} = j {X}_{s} + j {X}_{p} , and \\ {Z}_{o 0} ( j {ω}_{z} ) = \frac{j {X}_{p} {X}_{s}}{{X}_{p} + {X}_{s}} .$$

8. A method for designing a parallel resonant series-series (“PRSS”) power converter, the method comprising:
selecting a primary inductance Lₚ, a secondary inductance Lₛ, a primary resistance rₚ, a secondary resistance rₛ, a primary quality factor Q₁, and a secondary quality factor Q₂ for a loosely coupled transformer comprising a primary charging pad and a secondary pad, a range of coupling coefficients k of the transformer, and a switching frequency ωₛ of a switching section of the power converter;
selecting a capacitance for a primary series capacitor Cₚₛ connected in series with a primary winding of the transformer and a secondary series capacitor Cₛₛ connected in series with a secondary winding of the transformer, wherein the capacitance of the primary series capacitor Cₚₛ is chosen to be at a resonant frequency ωᵣ with the primary inductance Lₚ and wherein the capacitance of the secondary series capacitor Cₛₛ is chosen to be at the resonant frequency ωᵣ with the secondary inductance Lₛ, wherein the resonant frequency ωᵣ is equal to the switching frequency ωₛ; and
selecting a capacitance of a primary parallel capacitor Cₚₚ, of a parallel resonant tank, connected in parallel with the primary series capacitor Cₚₛ and the primary winding and an inductance of a primary resonant inductor Lₚᵣ, of the parallel resonant tank, connected in series between the output of the switching section and a connection between the primary parallel capacitor Cₚₚ and the primary series capacitor Cₚₛ, wherein an input impedance Zᵢ of the parallel resonant tank at a switching frequency ωₛ is below an intersection frequency fₘ intersecting an open circuit input impedance Z_{i∞}of the parallel resonant tank and a short circuit input impedance Zᵢ₀ of the parallel resonant tank,
wherein the power converter comprises a rectification section with an input connected to an output of the tuning section and an output connectable to a load.

9. The method of claim 8, wherein the switching section comprises four switches arranged in an H-bridge and the rectification section is configured as an H-bridge rectifier comprising an output capacitor C_{f} across output terminals of the output of the rectification section.

10. The method of claim 8, wherein the transformer comprises an air gap between the primary winding configured as a fixed primary charging pad and the secondary winding configured, wherein the secondary winding and the rectification section are one of mobile and stationary.

11. The method of claim 8, wherein the intersection frequency fₘ is defined as:
$${f}_{m} = \frac{1}{2 π \sqrt{2 {L}_{p r} {C}_{p p}}} .$$

12. The method of claim 8, wherein selecting the capacitance of the primary parallel capacitor Cₚₚ and the inductance of the primary resonant inductor Lₚᵣ comprises selecting the capacitance of the primary parallel capacitor Cₚₚ and the inductance of the primary resonant inductor Lₚᵣ to meet zero voltage switching conditions where the input impedance Zᵢ at the primary series capacitor Cₚₛ at the resonant frequency ωᵣ are defined by:
$$\vert {Z}_{i 1} ( {ω}_{r} ) \vert < {R}_{crit} , \\ where \\ {R}_{crit} = \vert {Z}_{o 0} \vert \sqrt{\frac{- {Z}_{i ∞}}{{Z}_{i o}}} , {ω}_{s} = {ω}_{r} , {X}_{s} = {ω}_{s} {L}_{pr} , {X}_{p} = - \frac{1}{{ω}_{s} {C}_{p p}} , {Z}_{i 0} = j {X}_{s} , {Z}_{i ∞} = j {X}_{s} + j {X}_{p} , and \\ {Z}_{o 0} ( j {ω}_{z} ) = \frac{j {X}_{p} {X}_{s}}{{X}_{p} + {X}_{s}} .$$

13. The method of claim 8, further comprising selecting an output voltage Vₒᵤₜ and output power Pₒᵤₜ at the load and determining an equivalent load resistance R_{L} at an input to the rectification section based on the selected output voltage Vₒᵤₜ and output power Pₒᵤₜ at the load, wherein:
$${R}_{L} = \frac{8 {V}_{o u t}^{2}}{{π}^{2} {P}_{o u t}} .$$

14. The method of claim 13, further comprising, for a lowest coupling coefficient k in a selected range, calculating an absolute value of input impedance |Zᵢ₁| at the primary series capacitor Cₚₛ at the resonant frequency ωᵣ, wherein the primary winding and the secondary winding are coupled with the coupling coefficient k, and wherein the input impedance Zᵢ₁ at the primary series capacitor Cₚₛ is defined as:
$${Z}_{i 1} ( {ω}_{r} ) = {r}_{s} + \frac{{{ω}_{r}^{2} ( k \sqrt{{L}_{p} {L}_{s}} )}^{2}}{{R}_{L} + {r}_{s}} ,$$
and calculating a root-mean-square (“RMS”) value of current I_{Prms} at the primary series capacitor Cₚₛ is
$${I}_{P r m s} = \frac{{I}_{p}}{\sqrt{2}}$$
wherein Iₚ comprises an input current to the primary series capacitor capacitor Cₚₛ is Cₚₛ.

15. The method of claim 14, further comprising selecting a maximum open circuit voltage V_{oc} and a maximum short circuit current I_{sc} at the primary series capacitor Cₚₛ based on:
$$\frac{{\vert v \vert}^{2}}{{V}_{oc}^{2}} + \frac{{\vert {i}_{p} \vert}^{2}}{{I}_{SC}^{2}} = 1.$$

16. A wireless power transfer (WPT) power converter comprising:
a switching section comprising four semiconductor switches arranged in an H-bridge;
a tuning section with an input connected to an output of the switching section, the tuning section comprising:
a loosely coupled transformer comprising a primary inductance Lₚ and a secondary inductance Lₛ, wherein the transformer comprises an air gap between the primary winding configured as a primary charging pad and the secondary winding;
a primary series capacitor Cₚₛ connected in series with a primary winding of the transformer and a secondary series capacitor Cₛₛ connected in series with a secondary winding of the transformer, wherein the primary series capacitor Cₚₛ is chosen to be at a resonant frequency ωᵣ with the primary inductance Lₚ and wherein the secondary series capacitor Cₛₛ is chosen to be at the resonant frequency ωᵣ with the secondary inductance Lₛ, wherein the resonant frequency ωᵣ is equal to the switching frequency ωₛ;
a primary parallel capacitor Cₚₚ, of a parallel resonant tank connected in parallel with the primary series capacitor Cₚₛ and the primary winding; and
a primary resonant inductor Lₚᵣ, of the parallel resonant tank connected in series between the output of the switching section and a connection between the primary parallel capacitor Cₚₚ and the primary series capacitor Cₚₛ, wherein an input impedance Zᵢ of the parallel resonant tank at a switching frequency ωₛ is below an intersection frequency fₘ intersecting an open circuit input impedance Z_{i∞} of the parallel resonant tank and a short circuit input impedance Zᵢ₀ of the parallel resonant tank, wherein the intersection frequency fₘ is defined as:
$${f}_{m} = \frac{1}{2 π \sqrt{2 {L}_{p r} {C}_{p p}}} ;$$
and
a rectification section with an input connected to an output of the tuning section and an output connectable to a load, the rectification section is configured as an H-bridge rectifier comprising an output capacitor C_{f} across output terminals of the output of the rectification section, wherein the secondary winding and the rectification section are one of mobile and stationary.

17. The WPT power converter of claim 16, wherein the primary winding and the secondary winding are coupled with a coupling coefficient k that is related to root-mean-square (RMS) current I_{Prms} at the primary series capacitor Cₚₛ while output power Pₒᵤₜ at the load is substantially constant according to the equation:
$${P}_{out} = \frac{{{ω}_{r}^{2} ( k \sqrt{{L}_{p} {L}_{s}} )}^{2} {I}_{P r m s}^{2}}{{R}_{L} + {r}_{s}} ,$$
wherein:
rₛ is a resistance of the secondary winding; and
R_{L} is a load impedance from an input to the rectification section.

18. The WPT power converter of claim 16, wherein the primary resonant inductor Lₚᵣ and the primary parallel capacitor Cₚₚ are chosen such that the switching section operates as zero voltage switching for a conditions where the input impedance Zᵢ₁ at the primary series capacitor Cₚₛ at the resonant frequency ωᵣ are defined by:
$$\vert {Z}_{i 1} ( {ω}_{r} ) \vert < {R}_{crit} , \\ where \\ {R}_{crit} = \vert {Z}_{o 0} \vert \sqrt{\frac{- {Z}_{i ∞}}{{Z}_{i o}}} , {ω}_{s} = {ω}_{r} , {X}_{s} = {ω}_{s} {L}_{pr} , {X}_{p} = - \frac{1}{{ω}_{s} {C}_{p p}} , {Z}_{i 0} = j {X}_{s} , {Z}_{i ∞} = j {X}_{s} + j {X}_{p} , and \\ {Z}_{o 0} ( j {ω}_{z} ) = \frac{j {X}_{p} {X}_{s}}{{X}_{p} + {X}_{s}} .$$

19. The WPT power converter of claim 16, wherein for a selected output voltage Vₒᵤₜ and for a selected output power Pₒᵤₜ at the load, an equivalent load resistance R_{L} at an input to the rectification section is based on the selected output voltage Vₒᵤₜ and output power Pₒᵤₜ at the load, wherein:
$${R}_{L} = \frac{8 {V}_{o u t}^{2}}{{π}^{2} {P}_{o u t}} .$$

20. The WPT power converter of claim 19, wherein a root-mean-square (RMS) value of current I_{Prms} at the primary series capacitor Cₚₛ is calculated as
$${I}_{P r m s} = \frac{{I}_{p}}{\sqrt{2}}$$
where Iₚ comprises an input current at the primary series capacitor Cₚₛ, wherein the primary winding and the secondary winding are coupled with a coupling coefficient k and the input impedance Zᵢ₁ at the primary series capacitor Cₚₛ at the resonant frequency ωᵣ is defined as:
$${Z}_{i 1} ( {ω}_{r} ) = {r}_{s} + \frac{{{ω}_{r}^{2} ( k \sqrt{{L}_{p} {L}_{s}} )}^{2}}{{R}_{L} + {r}_{s}} ,$$
wherein:
rₛ is a resistance of the secondary winding; and
R_{L} is a load impedance from an input to the rectification section, and
a maximum open circuit voltage V_{oc} and a maximum short circuit current I_{sc} at the primary series capacitor Cₚₛ are determined based on:
$$\frac{{\vert v \vert}^{2}}{{V}_{oc}^{2}} + \frac{{\vert {i}_{p} \vert}^{2}}{{I}_{SC}^{2}} = 1.$$
